(19) United States
(12) Patent Application Publication
(10) Pub. No.: US 2002/0095338 A1
(43) Pub. Date: Jul. 18, 2002

(54) System and method for propagating virtual advertising images

(75) Inventors: Antonio Carlos Ferreira do Amaral e Silva, Rio de Janeiro (BR); Ricardo Augusto da Cunha Dias, Rio de Janeiro (BR)

Correspondence Address: SMITH, GAMBRELL & RUSSELL, LLP, Suite 800, 1850 M Street, Washington, DC, 20036, US

(73) Assignee: Trip Informatica Ltda.

(21) Appl. No.: 10/003,483

(22) Filed: Dec. 6, 2001

(30) Foreign Application Priority Data
Dec. 6, 2000 (BR) PI0005739-8

(51) Int. Cl. G06F 17/60

(52) U.S. Cl. 705/14

(57) ABSTRACT

The present invention relates to a system and method of propagating images by stimulating memorization by a user of images or any other advertising contents. Memorization takes place by virtue of the interactive entertainment of the user with the advertising contents of the advertisers/sponsors of the event.

### FIELD OF THE INVENTION

The present invention relates to a mechanism for working, by means of databanks or files, with virtual images stored in a magnetic medium. Such databanks enable these images to relate to one another. The project is preferably intended to be used in the Internet, for the purpose of creating a new way of propagating advertising images. As the images are virtually manipulated by the users in the form of entertainment, memorization of the product, mark, company, etc. gradually takes place.

### DESCRIPTION OF THE STATE OF THE ART

The most usual propagation way in the Internet over the years has been by sending the advertisement by means of banners. Although this form of advertisement is still much used and, to a certain degree, effective, when Internet users are looking for certain matters connected with the product advertised in the banner, it becomes exhausted as times passes. It has been found that most banners are not effective in their task of propagating the images of the advertisers into the memory of users, since most users do not “click” on the banner to know what exists there.

In an attempt at solving the above problem, an advertising mode has been created, in which the propagating of images takes place at the moment when the user is looking for a given key-word or information. The procedure is performed as follows: the user enters the word which he wants to find in the search site and, when he tries to access the site listed in the results, the advertisement inserted into the site automatically appears on the computer screen in the form of an extra page. Well, this irritates the user, whose first reaction is to close all the windows and not to return any more to the site in which he was searching, that is to say, in this case the advertisement is often negative.

The PCT patent application published under No. WO 00/48069 describes a type of system that tries to solve some problem of the drawbacks of the prior art by means of a device that causes the information of the advertisers to be exhibited on the side opposite the displacement of the mouse cursor. For instance, if the cursor is moving downwards, the image will be exhibited on the upper part. If the cursor is being moved in a circle, the image will be moved to the corner of the screen or simply disappear until the mouse movement stops. In this way, one tries to minimize the nuisance that a badly-positioned advertisement may cause to the iternaut. In addition to the fact that this objective is not achieved, there is no relationship of the user with the advertisement that is being dragged by the mouse, that is, the user is not interacting with the advertisement. Therefore, the referred-to advertisement is often not memorized or accepted by the user, besides causing his irritation with the advertiser.

U.S. Pat. No. 5,823,879 describes a mode of participation in an Internet event through using a computerized advertising system to exchange information relating to the goods and/or services among the users and advertisers. In this case, one tries to associate the advertisement in an entertainment environment. However, the way in which the information about products appears does not stimulate the person who is participating in the event to get in touch with the advertiser, in order to obtain information on the product. Thus, the advertisement is conveyed by means of information contained in hypertext links, which acts as conventional banners and does not have any relationship with entertainment.

### OBJECTIVES OF THE INVENTION

An objective of the present invention is to enable users to memorize the images that are conveyed during their participation in the event.

Another objective of the present invention is to cause this storage to be rapid and lasting with respect to the images that are conveyed during the entertainment.

A further objective of the present invention is to provide entertainment to those who are participating in the image-propagating event.

Moreover, yet a further objective of the present invention is to give prizes to those who manage to reach determined goals established in the course of the advertising event.

The objectives described above are achieved by means of the image-propagating system that will be described in detail later.

### SUMMARY OF THE INVENTION

According to the teachings of the present invention, a visual image propagating system and its components are described here.

This is the creation of a mechanism for working with virtual images stored in databanks.

The system for propagating data with visual characteristics may be downloaded from the global computer network. It basically comprises first and second visual-image databanks. These are capable of interacting virtually with each other, so as to produce an event. There is also a third visual-image data bank for supplying data to the second data bank and interacting with the other two banks, so that the event can have characteristics of an entertainment environment for the user.

Preferably, the databanks contain images from advertisers for propagating advertisements or images of an educative nature. Such images of an educative nature may be questions or games that aim at providing information to a user, preferably to a child.

One may include a fourth static image data bank that will serve the objective of entertainment, in which a user will be interacting with the other databanks and always looking for a means of causing these to have the contents of the fourth data bank. The interaction of data between first and second databanks will directly influence the constitution of third data bank, and the modification in the data of the latter will permit change in the data of the second data bank. In this way, the three databanks interact with each other by means of a user, so as to form, in the third data bank or in an additional data bank, an image. In the system of the present invention there is the possibility of exchanging data by dragging the images contained in the first and second databanks so as to enable one to overlap them. The exchange of data and the overlapping of the images may also be carried out by means of a mouse click directly on the images contained in the first and second databanks. The images of each of the first and second databanks are arranged side by side and overlapping each other.

The event may develop with the user directly connected to the global network or not. A virtual control station controlling and managing the steps of the event when the station is connected to the global computer network. The images of the databanks are susceptible of being combined and removed from over each other in a simple way.

A device records in a virtual or physical memory the whole interaction of a user with the databanks of said system. Such interaction between the data of the databanks of the system provides an amusing and/or educative entertainment to the user. The entertainment develops in a real time in the Internet or from data stored in a data-storing unit. Said data-storing unit is a compact disc or a computer hard disc.

The amusing and/or educative entertainment for a user also provides prizes. The prizes are established by the control station as the user interacts with said system and achieves the goals established by the databanks.

The present invention also describes a method of propagating data with visual characteristics comprising at least the steps of creating a minimum of three visualimage databanks, permitting the transposition of the virtual images from a local databank to the others so as to create an event with entertainment characteristics and verify the similarity of the images between at least two databanks.

The constitution of at least one of the databanks is effected by storing images from advertisers and/or storing educative images. In this method, the transposition of images is carried out by a single mouse click or by dragging the image by a mouse cursor. After the step of verifying the similarity of the images of at least two databanks, the step of manual interaction between the user and the images of at least two databanks modifies the data of a third databank.

In addition, the step of manual interaction between a user and a third databank further modifies the data of at least two databanks. The manual interaction between the user and the images of at least two databanks also modifies the data of a third databank, so that they will be identical to the images of a fourth databank.

The method provides prizes to the user by means of a control station by meeting the parameters established by it. Such parameters are established in accordance with the interaction of the user with the virtual-image databanks.

In the first and best embodiment of the present invention, images from advertisers who have opted for the “Veiculo Publicitario Virtual” (Virtual Advertising Vehicle) are stored in a virtual advertising image databank (Db1). From this databank an interface is formed with the participants, that is to say, the Internet Users, exhibiting various Display Screens (sets of Virtual Places Db3), one by one, with a determined number of images on each, which may be handled and worked on virtually by the users.

The user, when involved in this mechanism, automatically receives for his “Key Personal Virtual-image Databank (Db9) a given number of images, which are stored there.

The various images displayed virtually to the user participating in the vehicle by means of the display screens, which form a set of “Key Local Images” (Db7) and are the keys for access to an “Image Databank Contents of a Place” (Db6) have the objective of controlling the access of the participating users to this databank. This happens if he has, in his “Key Personal Virtual-image Databank (Db9), some of the images shown on the display screens.

This virtual Advertising Vehicle contains an “Target Virtual Image Databank” (Db2), in which one stores images from advertisers who wish to exhibit their images as targets for the users participating in the event of the Virtual Advertising Vehicle.

As to the images of the “Target Virtual Image Databank” (Db2), it is to be noted that they are spread at random among the “Virtual Places” by means of the an “Image Databank Contents of a Place” (Db6) and that, when they are accessed by a user participating in the vehicle, the user participating in the vehicle is given a right to exchange one of the images of his “Key Personal Virtual-image Databank (Db9) for one from the “Image Databank Contents of a Place” (Db6).

The strategy used by the Virtual Advertising Vehicle to attract the users to participate in this image-propagating mechanism is to determine an amount of “Target Images” to be found by the user participating in the vehicle accessing the “Image Databank Contents of a Place” (Db6). Hence, during the accesses, the user participating in the vehicle may be given a prize by the advertisers of the “Advertising Virtual Image Databank” (Db1), according to the images which the user participating in the vehicle has, and causes this to form a combination of images equal to some image that is registered in the “Awarded Combined Images Databank” (Db8). And the main attraction for the user participating in the vehicle to participate in the Virtual Advertising Vehicle is that the first person who finds all the registers of the “Target Virtual Image Databank” (Db2) will be given a good prize by the advertisers of this databank.

It should be noted that the entertainment may be performed either directly online via the Internet or off-line by downloading the files necessary for a perfect utilization of the image-propagating system.

### BRIEF DESCRIPTION OF THE FIGURES

FIG. 1 shows the block diagram of preparation of the Databanks.

FIG. 2 shows the block diagram of the procedures to search for the Target Images.

FIG. 3 shows the block diagram of the procedures to use the Personal Agenda.

### DETAILED DESCRIPTION OF THE FIGURES

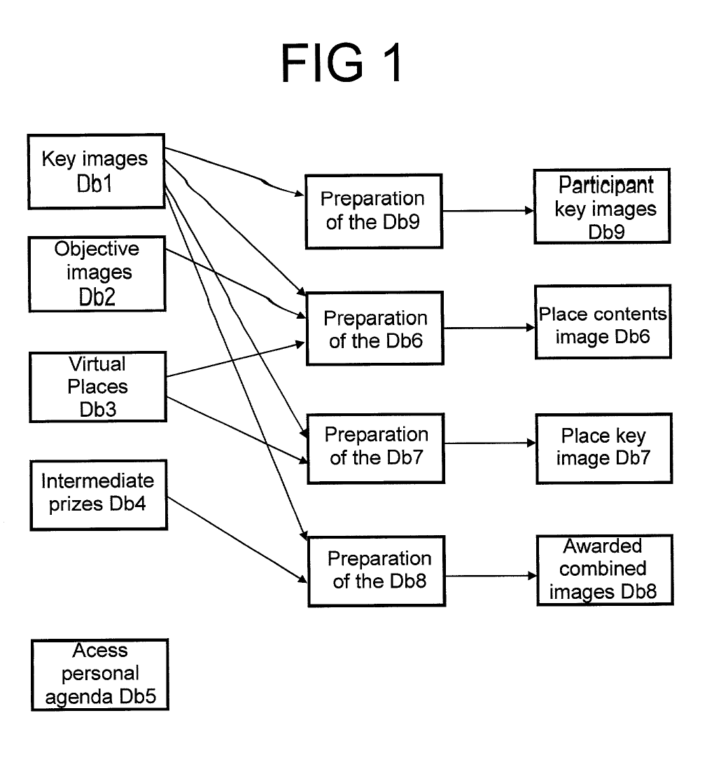

FIG. 1 illustrates the block diagram of the process of preparing the databanks (Db) involved in the Advertiser Image Propagating System. In preparing these databanks, one uses fixed(*) databanks of registered images and information.

Db1—*Advertising Virtual Image Databank, “Key Images”

Db2—*Target Virtual Image Databank, “Target Images”

Db3—*Virtual Places Databank “Virtual Places or Display Screen”

Db4—Intermediate Prize Databank “Prizes”

Db5—*Participant's Access Databank “Personal Agenda”

Db6—Contents Image Databank of a Place “Place Contents Image”

Db7—Image Databank of Access to a Place “Place Key Image”

Db8—Awarded Combined Image Databank “Awarded Combined Image”

Db9—Personal Key Virtual Image Databank “Participant's Key Images”

Preparation of the Db6—The “Place Contents Image” is prepared by an automatic procedure, in which a “Key Image” (Db1) or a “Target Image” (Db2), entitled “contents”, is randomly distributed to each “Virtual Place” (Db3).

Preparation of the Db7—The Image Databank of Access to a Place is prepared by an automatic procedure that randomly distributes to each “Virtual Place” (Db3) a “Key Image” (Db1), entitled “access key”.

Preparation of the Db8—The Awarded Combined Image Databank is prepared by an automatic procedure comprising a random combination of more than two “Key Images” (Db1) with a combination formed from the distribution of the “intermediate prizes” (Db4). This generates the award of prizes for such a combination.

Preparation of the Db9—The Personal Key Virtual Image Databank is prepared by an automatic procedure in which the participant, upon registering, randomly receives a stipulated amount of images from the “Key Images”.

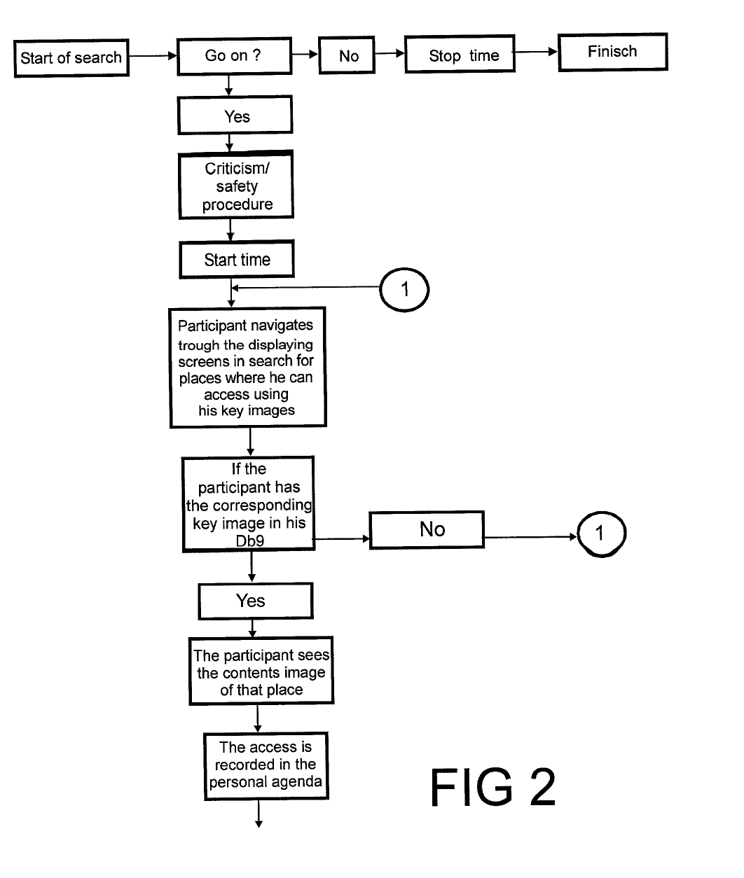

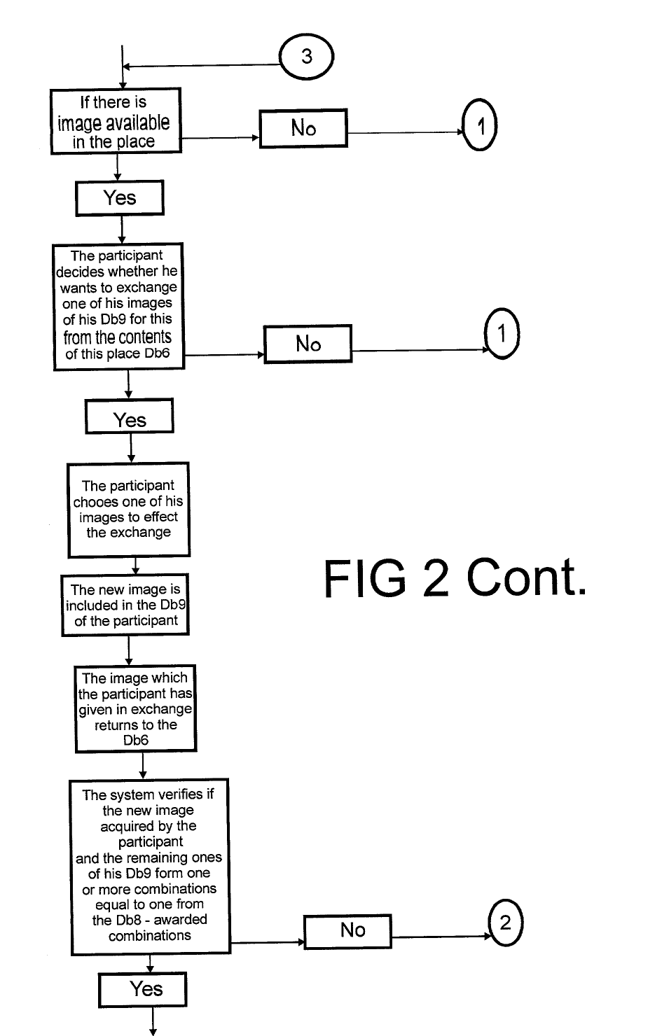

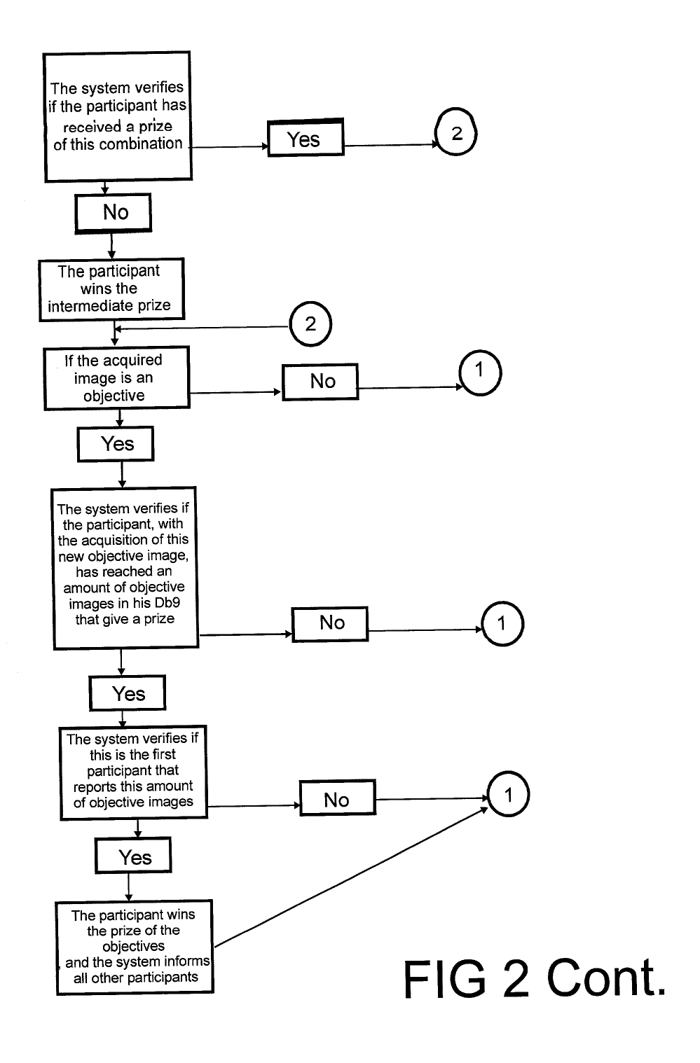

The Participant's Access Databank (Db5) is generated by an automatic procedure that is part of the procedure of Search for “Target Images” (FIG. 2).

All the databanks involved in the “Advertiser's Image Propagating System”may be recorded in the equipment of the participants by Download or by an installation CD. The control databanks responsible for the safety and effectiveness of the system will be on the server accessed through Internet.

FIG. 2 illustrates the procedures of searching for “Target Images” that form the process of propagating images.

The registration of a participant is effected from the moment when he decides to enter the event, that is, in the image-propagating process. Then, to effect the registration, it is necessary to make a register of the personal data and/or any others of a user and also his agreement with the terms stipulated by the event managing and controlling station, where the control databanks are located.

The user may not have more than one registration, but he may install the system in more than one computer. In order to prevent the user from participating through more than one piece of equipment at the same time, the registration is checked on-line. Then, the following routine is performed: a) the duration of the challenge/event is verified, which may last several days or months; b) the time that the user participating in the daily or weekly event is verified; c) a device controls the time interval that the participant accesses the places, so as not to permit utilization of routines programmed for searching the Target Images—in case a wait routine is activated and the access is controlled; d) the registration is verified as to whether it is suspended for reasons stipulated in the term signed by the user at the beginning.

The participant should search for the Target images Db2 so that he can gain the prizes offered. Thus, he should verify if his databank has the image that enables him to access the “virtual places” Db3. Please note that, in order to enter into the “virtual places”, it is necessary for the participant to have an identical image to “open” the place and to see what is there.

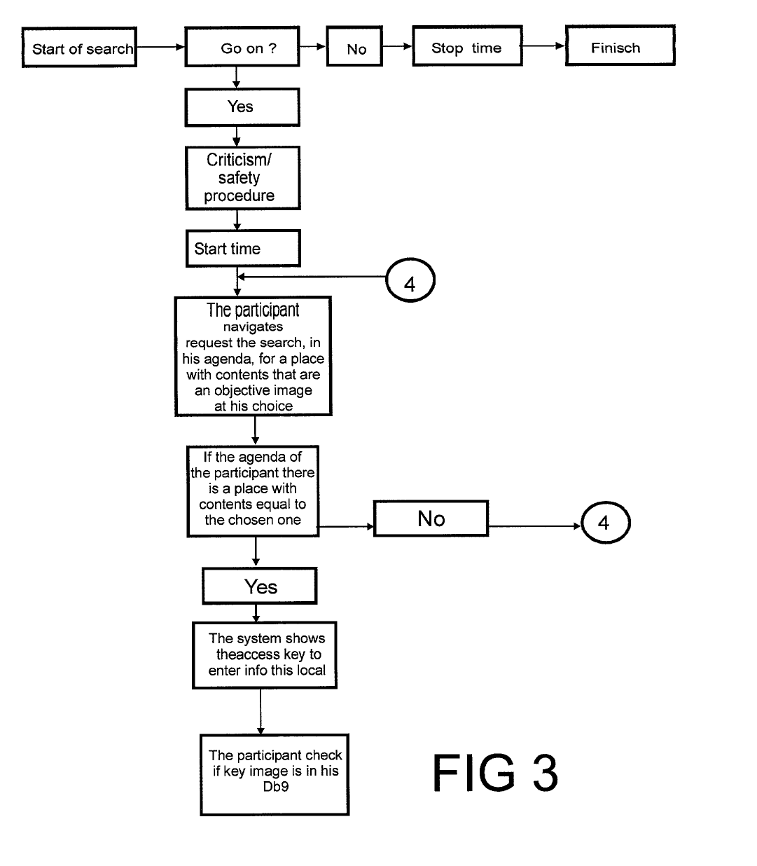

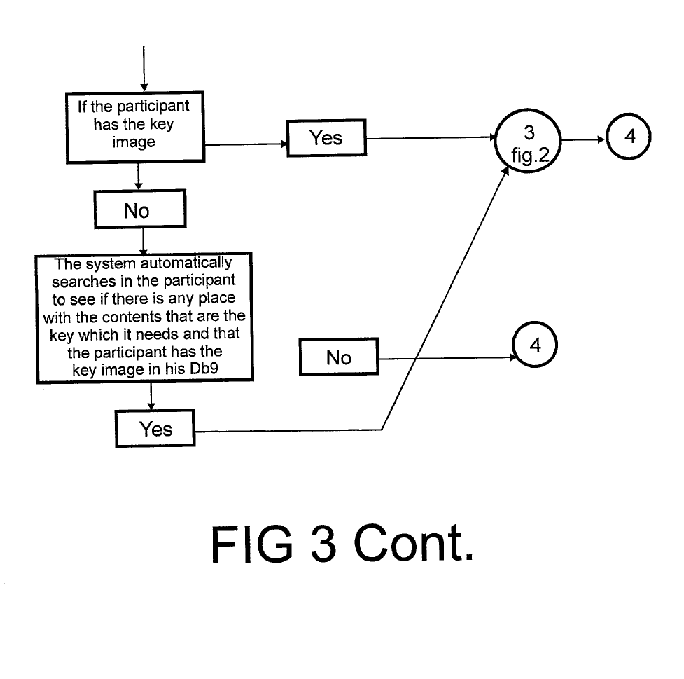

If the participant has an access image, he can enter into the place; if not, he will have to search for these images so that he can enter into the place and see its contents. If there are copies available in the place, he may effect exchange of one of his images. Note that this procedure is stored in the memory of a second agenda. Such an agenda is used to store information about the places the participant has visited. The agenda is very important to the participant, since the number of places already visited may be very large and, therefore, the participant will hardly remember all of them and how he got there. This agenda makes available an automatic search procedure in the places visited by the participant, as illustrated in FIG. 3.

As already mentioned, there is the possibility of the participant exchanging images, if he notices that they are necessary to achieve better results during his participation in the event.

After the image to be exchanged has been chosen, it is returned to its origin and a newly received image is stored in the databank of the participant.

Throughout the event, the control and management station will be checking if someone has already achieved the main goals or the intermediate goals, which are randomly established. These goals comprise the formation of certain groups of images from the advertisers.

FIG. 3 illustrates the use of the personal agenda, which facilitates better participation by the users, since this makes it easier to locate the Target. When a target is located, it is also necessary to verify if the participant has a key to provide access to the contents of this place. If the participant has an access key, he can acquire the image he wants. If he does not have the keys, he has to try to locate the places containing the access key, be it with the help of that agenda or not. When the user finds what he is looking for, he simply acquires the required key.

After the participant makes an excursion through the agenda and gets what he needs, he can return to the event in better conditions to participate.

Throughout the event the participant may “win a prize” with the “master key”, and this device will allow him to access any place for a time interval determined by the control and management station. In this way, the participant can try to “open”/visit as many places as he wishes. As he enter the places, the agenda will automatically record them, which will facilitate a subsequent consultation, if necessary.

It should be noted that the function of the images on the display screens in the sense of providing access to contents image of a particular place in the system of the present invention may be replaced by texts or any other mechanism that enables the interaction of the user in the event. In other words, the entry into a certain place may not be conditional upon the similarity of the key images and the display screens. One may use, for instance, a question-and-answer criterion. The right answer will give access to the desired places.

Therefore, it should be understood that the system and method of the present invention, and its component parts described above, are only a few of the embodiments and examples of situations that might occur, and the real scope of the invention is defined in the accompanying claims.

1- A data-propagating system with visual characteristics from the global computer network, comprising:
a first virtual-image databank;
a second virtual-image databank, said first and second virtual databanks being capable of virtually interacting with each other so as to bring about an event;
a third virtual-image databank for supplying data to the second databank and interacting with the other two databanks, so that the event can have characteristics of an entertainment environment for a user.

2. A system according to claim 1, wherein the databanks preferably contain images from advertisers for propagating advertisements.

3. A system according to claim 1 or 2, wherein the databanks contain images of educative nature.

4. A system according to claim 1, characterized by comprising a fourth static image databank.

5. A system according to claim 1, wherein the interaction of data between first and second databanks will directly influence the constitution of the third databank.

6. A system according to claim 1, wherein modification of the data of the third databank enables one to modify the data of the second databank.

7. A system according to claim 1, wherein at least the three databanks interact with each other by means of a user so as to form, in the third databank or in an additional databank, an image viewed in the fourth databank.

8. A system according to claim 1, wherein it enables one to exchange data by dragging of the images contained in the first and second databanks, so as to allow them to be overlapped.

9. A system according to claim 1, wherein it enables one to exchange data by directly clicking with the mouse on the images contained in the first and second databank, thus allowing them to be overlapped.

10. A system according to claim 8 or 9, wherein the images of each of the first and second databank are arranged side by side and overlapping each other.

11. A system according to claim 1, wherein the event may develop with the user being directly connected to the global computer network.

12. A system according to claim 1, wherein the event may develop without the user being directly connected to the global computer network.

13. A system according to claim 1 or 11, comprising a virtual control station that controls and manages the steps of the event when the user is connected to the global computer network.

14. A system according to claim 1, wherein the images of the databank are susceptible to being combined and removed from over each other.

15. A system according to claim 1, having a device that records, in a virtual or physical memory, all the interaction of a user with the databanks of said system.

16. A system according to claim 1, wherein the interaction between the data of the databanks of the system provide amusing or educative entertainment to the user.

17. A system according to claim 1 or 16, wherein the entertainment develops in real time in the Internet, or from data stored in a data-storing unit.

18. A system according to claim 17, wherein the data-storing unit is a compact disc or a computer hard disc.

19. A system according to claim 16, wherein the amusing or educative entertainment for a user provides prizes.

20. A system according to claim 13, wherein the prizes are established by the control station as the user interacts with said system and meets the goals established by the databanks.

21. A method of propagating data with visual characteristics, comprising the following steps:
creating at least three virtual-image databank;
transferring the virtual images from a local databank to others, so as to create an event with entertainment characteristics; and
verifying the similarity of the images between at least two databanks.

22. A method according to claim 21, wherein the constitution of at least one of the databanks takes place by storing advertisers' images.

23. A method according to claim 21, wherein the constitution of at least one of the databanks is effected by storing images of an educative nature.

24. A method according to claim 21, wherein the transfer of images is carried out by a single mouse click or by dragging the image with the mouse cursor.

25. A method according to claim 21, wherein, after the step of verifying the similarity of the images of at least two databanks, the step of manual interaction between a user and the images of at least two of the databanks modifies the data of a third databank.

26. A method according to claim 25, wherein the step of manual interaction between a user and a third databank modifies the data of at least two of the databanks.

27. A method according to claim 21 or 25, wherein the manual interaction between a user and the images of at least two of the databanks modifies the data of a third databank, so that they will be identical to the images of a fourth databank.

28. A method according to claim 21, providing prizes to the users by means of a control station upon the user meeting the parameters established by it.

29. A method according to claim 28, wherein the parameters are achieved as the user interacts with the virtual-image databanks.
